(19) United States
(12) Patent Application Publication
(10) Pub. No.: US 2004/0224649 A1
(43) Pub. Date: Nov. 11, 2004

(54) Electronically tunable power amplifier tuner

(76) Inventor: Khosro Shamsaifar, Ellicott City, MD (US)

Correspondence Address: James S. Finn, 8650 Southwestern Blvd. #2825, Dallas, TX, 75206-2688, US

(21) Appl. No.: 10/717,016

(22) Filed: Nov. 19, 2003

Related U.S. Application Data
(60) Provisional application No. 60/445,336, filed on Feb. 5, 2003.

(51) Int. Cl. H04B 1/02

(52) U.S. Cl. 455/107; 455/91

(57) ABSTRACT

A tunable power amplifier which comprises at least one input matching circuit receiving an RF signal from an RF input and creating a first output RF signal, said at least one input matching circuit including at least one voltage tunable varactor to enable center frequency tuning; a first amplifier receiving said first output RF signal from said at least one input matching circuit and creating a second output signal, said second output signal providing input for at least one inter-stage matching circuit, said at least one inter-state matching circuit creating a third output signal; a second amplifier receiving said third output signal and creating a fourth output signal; an output matching circuit receiving said fourth output signal and generating an RF output signal; and an embedded controller associated with said input matching circuit, inter-stage matching circuit and output matching circuit for frequency tuning control. The tunable power amplifier of the present invention can also include one additional inter-stage matching circuit and wherein said at least one inter-stage matching circuit includes at least one tunable varactor to enable center frequency tuning.

### CROSS-REFERENCE TO RELATED APPLICATION

This application claims priority to U.S. Provisional Patent Application Ser. No. 60/445,336, “ELECTRONICALY TUNABLE POWER AMPLIFIER TUNER” filed Feb. 5, 2003, by Khosro Shamsaifar.

### BACKGROUND OF THE INVENTION

The present invention generally relates to tunable impedance matching networks for power amplifiers and tunable dielectric capacitors.

A frequency tunable RF front-end allows a single module to be intelligent in utilizing many designated transmit and receive frequency bands for frequency agile communications, including wireless and mobile communications. The design of an Intelligent RF Front end requires that it is adaptable to variations of signal intensity, field parameters, and manufacturing tolerances at all times and over the entire range of frequency it is supposed to operate. Therefore, it is imperative that the components for this front end be electronically tunable with a feedback loop for continuous adaptability. Also, every stage of the RF design must not only be matched properly to the previous and the subsequent stage, the matching stages should also be continuously adaptable and meet the specifications required. Matching networks are a staple for any transceiver design. They guarantee maximum transfer of power from a source to a load. As a result they appear everywhere in the design of an RF front end, including even for matching one amplifier stage to another.

In particular, the matching network of an amplifier in a broadband application should be considered very carefully in order to meet the gain requirement over the entire frequency band, as well as to reduce the intermodulation distortion and to operate efficiently in the linear region of the power amplifier. Conventional amplifiers become nonlinear when driven to produce higher output power levels. As a result, the signal from one communication channel is degraded by signals from one or more other channels located elsewhere in the frequency band of interest. This is known as intermodulation distortion.

Complex amplifiers must be used to avoid intermodulation distortion. However, these amplifiers are expensive both to make and to operate. While providing a linear output at relatively high output power levels, these amplifiers consume significantly more power than conventional amplifiers. The consumed power manifests itself as heat, which must be dissipated in order to prevent adverse effects on other components. As a result, the system must be provided with a structure that dissipates the heat. It is well known from basic transmission theory that any impedance mismatch creates a point of reflection of an applied signal wave. Further, the higher the degree of mismatch, the lower the return loss and the higher the level of reflected power. However, while the concept of broadband impedance matching is known, there remains a need in the art to properly design means to provide a tunable circuit that matches the input and output impedance of the amplifier over a wide frequency range. In addition to providing tunability over a wide band, such a tuning circuit has to be low loss and very linear, so that it does not degrade the linearity of the power amplifier.

Another application of an electronically tunable matching circuit is for use in a PA Tuner. Such a tuner will provide a good match between the output of a power amplifier, normally 50 Ohm, and any load impedance presented to the amplifier by the antenna. Again, because this tuner network is located at the output of the P A, it needs to be very low loss and very linear.

Thus, there is a strong need in the communications industry to provide an RF Front end that has a wide band matching network as well as PA tuner that will combine the benefits of the two and can match the output of the power amplifier to any random load over a wide frequency band.

### SUMMARY OF THE INVENTION

The present invention provides a tunable power amplifier which comprises at least one input matching circuit receiving an RF signal from an RF input and creating a first output RF signal, said at least one input matching circuit including at least one voltage tunable varactor to enable center frequency tuning; a first amplifier receiving said first output RF signal from said at least one input matching circuit and creating a second output signal, said second output signal providing input for at least one inter-stage matching circuit, said at least one inter-stage matching circuit creating a third output signal; a second amplifier receiving said third output signal and creating a fourth output signal; an output matching circuit receiving said fourth output signal and generating an RF output signal; and an embedded controller associated with said input matching circuit, inter-stage matching circuit and output matching circuit for frequency tuning control. The tunable power amplifier of the present invention can also include one or more additional inter-stage matching circuits and wherein said at least one inter-stage matching circuit includes at least one tunable varactor to enable center frequency tuning. Further, the at least one output matching circuit can include at least one tunable varactor to enable center frequency tuning.

Also, in accordance with the present invention is provided a method of tuning a power amplifier, comprising the steps of: providing at least one input matching circuit receiving an RF signal from an RF input and creating a first output RF signal, said at least one input matching circuit including at least one voltage tunable varactor to enable center frequency tuning; providing a first amplifier receiving said first output RF signal from said at least one input matching circuit and creating a second output signal, said second output signal providing input for at least one inter-stage matching circuit, said at least one inter-stage matching circuit creating a third output signal; providing a second amplifier receiving said third output signal and creating a fourth output signal; providing an output matching circuit receiving said fourth output signal and generating an RF output signal; and adjusting the frequency tuning with an embedded controller associated with said input matching circuit, inter-stage matching circuit and output matching circuit.

Another embodiment of the present invention discloses a tunable power amplifier feedback loop, comprising: a tuner with at least one tunable varactor receiving a first output RF signal obtained from said tunable power amplifier; a directional coupler for obtaining a sample of a second output signal output from said tuner and passing said sample of said second output RF signal to a detector for measuring said sample of said second output signal from said tuner; a controller to determine if said second output RF signal is a maximum RF signal and, if not, for adjusting a voltage applied to said at least one voltage tunable varactor in said tuner to modify subsequent outputs from said tuner.

### BRIEF DESCRIPTION OF THE DRAWINGS

FIG. 1 is a block diagram of the tunable power amplifier of the present invention;

FIG. 2 is a schematic of the last stage of the power amplifier of the present invention;

FIG. 3 is a graphical depiction of the gain of the amplifier at three tuning frequencies;

FIG. 4 graphically depicts the return loss of the amplifier at three frequency tunings;

FIG. 5 is a block diagram of a power amplifier tuner of the present invention;

FIG. 6 is a block diagram of a tunable RF Front End for the handset of the present invention and including tunable LNAs and PAs;

### DESCRIPTION OF THE PREFERRED EMBODIMENT

The present invention sets forth electronically tunable matching circuits for power amplifiers used in wireless and mobile communications. In a first preferred embodiment, these tuning networks can be used to provide a match, over a wide frequency band, between the amplifier and the 50 Ohm impedance presented by the neighboring components. In another application as PA tuner, the output of the power amplifier can be matched to any random impedance presented by the antenna. This is achieved by providing a feedback loop in the output of the PA and maximizing the output power. Also, both applications can be combined to create a third application where any load impedance could be matched to the amplifier over a wide frequency band. All embodiments can utilize voltage-controlled tunable dielectric capacitors as tuning elements. These varactors show high Q, especially at high frequencies, and are very linear with very good IP3. The present invention makes wide band tunable power amplifiers possible in the contemporary wireless and mobile communication system applications.

An electronically tunable matching network provides enhanced performance by:

offering better out-of-band spurious rejection as compared to the fixed broadband power amplifier;

more control in “tuning out” the performance variations in the amplifier devices, resulting from its manufacturing tolerances;

reversal of the amplifier aging process and restoration to its top performance via recalibration of the tunable matching network, thus resulting in longer life of the product.

In addition, the power handling capability and linearity of the matching network will determine if it can be utilized for both transmit and receive applications. Inherent in every tunable matching circuit is the ability to rapidly tune the response using “TU” high-impedance control lines. The tunable materials disclosed herein and in the patents and patent applications incorporated herein by reference enables these tuning properties, as well as, high Q values, low losses and extremely high IP3 characteristics, even at high frequencies.

The tunable dielectric capacitor in the present invention is made from low loss tunable dielectric film. The range of Q factor of the tunable dielectric capacitor is between 50, for very high tuning material, and 300 or higher, for low tuning material. It also decreases with increasing the frequency, but even at higher frequencies, say 30 GHz, can take values as high as 100. A wide range of capacitance of the tunable dielectric capacitors is available, from 0.1 pF to several pF. The tunable dielectric capacitor is a packaged two-port component, in which the tunable dielectric can be voltage-controlled. The tunable film is deposited on a substrate, such as MgO, LaAIO3, sapphire, AhO3 or other dielectric substrates. An applied voltage produces an electric field across the tunable dielectric, which produces an overall change in the capacitance of the tunable dielectric capacitor.

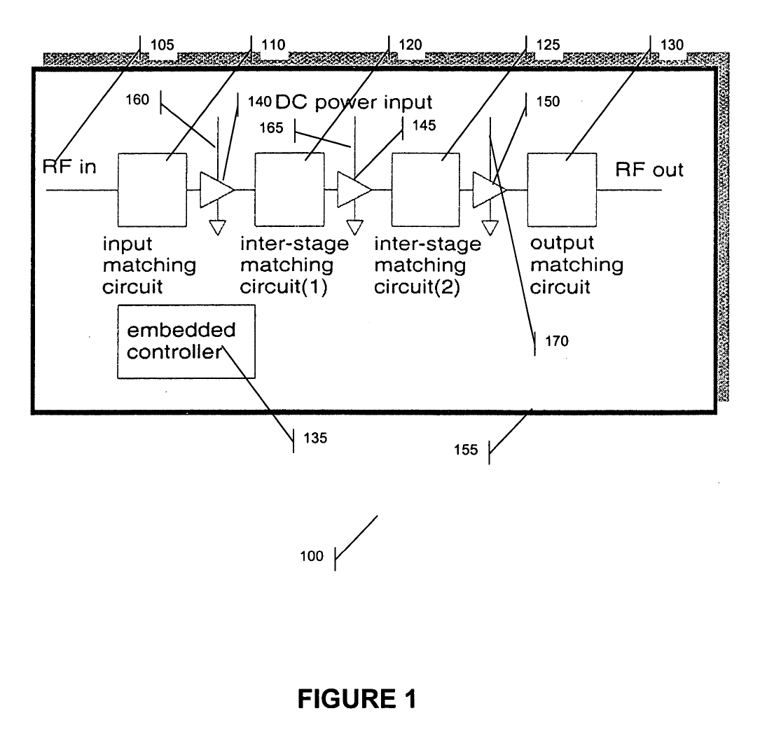

In a first embodiment, tuning networks are designed to provide match at the input and output of the amplifier, as well as between the amplifier stages. Referring now to FIG. 1, at 100, a block diagram illustrates the proposed tunable microwave power amplifier with tuning range from 100 Hz to 180 Hz. The diagram shows three amplifier devices 140, 145 and 150 with four matching networks: 110, which illustrates the input matching circuit; 120, illustrating the first inter-stage matching circuit; 125, illustrating the second inter-stage matching circuit; and 130, which depicts the output matching circuit. An embedded controller 135 within the amplifier enclosure 155 performs all the tasks related to the frequency tuning control. Power for the tunable dielectric capacitors is provided by DC power inputs, 160, 165 and 170.

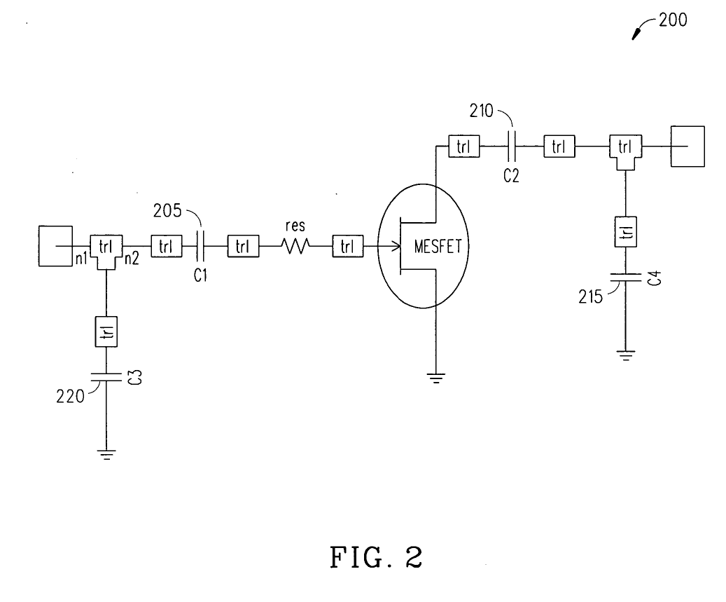

FIG. 2 at 200 shows the schematic of the last stage along with its tunable matching circuits. The bias and control circuits are not shown here but are known and can be implemented by those of reasonable skill in the art. By varying the bias voltages on the varactors C1 at 205, C2 at 210, C3 at 220 and C4 at 215, their capacitance values will vary, which will in turn tune the center frequency from 11.55 GHz to 17.55 GHz with an instantaneous bandwidth of 100 MHz. It is understood that although those frequency ranges are given herein, other frequency ranges are readily attainable. Voltage tunable varactors that can be used in the present invention are described in detail in U.S. Pat. No. 6,531,936, entitled, Voltage Tunable Varactors and Tunable Devices Including Such Varactors” issued on Mar. 11, 2003 and assigned the assignee of the present invention. In this patent a voltage tunable dielectric varactor includes a substrate having a low dielectric constant and having generally planar surface, a tunable ferroelectric layer positioned on the generally planar surface of the substrate, and first and second electrodes positioned on a surface of the tunable ferroelectric layer opposite the generally planar surface of the substrate. The first and second electrodes are separated to form a gap therebetween. The varactor includes an input for receiving a radio frequency signal and an output for delivering the radio frequency signal. A bias voltage applied to the electrodes changes the capacitance of the varactor between the input and output thereof.

Further, in patent application Ser. No. 09/434,433, entitled, “Ferroelectric Varactor with Built-In DC Blocks” filed Nov. 9, 1998, again assigned to the assignee of the present invention, additional information on varactors and their use is provided. This patent application describes a voltage tunable dielectric varactor that includes a tunable ferroelectric layer and first and second non-tunable dielectric layers. First and second electrodes positioned adjacent to the tunable ferroelectric layer form a tunable capacitor. A third electrode is positioned adjacent to the first non-tunable dielectric layer such that the third and first electrodes and the first non-tunable dielectric layer form a first blocking capacitor. A fourth electrode is positioned adjacent to the second non-tunable dielectric layer such that the fourth and second electrodes and the second non-tunable dielectric layer form a second blocking capacitor.

Both U.S. Pat. No. 6,531,936 and patent application Ser. No. 09/434,433 are incorporated in by reference in their entirety and for all purposes.

The matching circuits herein described were for an optimal output power, in this example, of 30 dBm. However, it is understood that the matching circuits can be varied depending on performance parameters required.

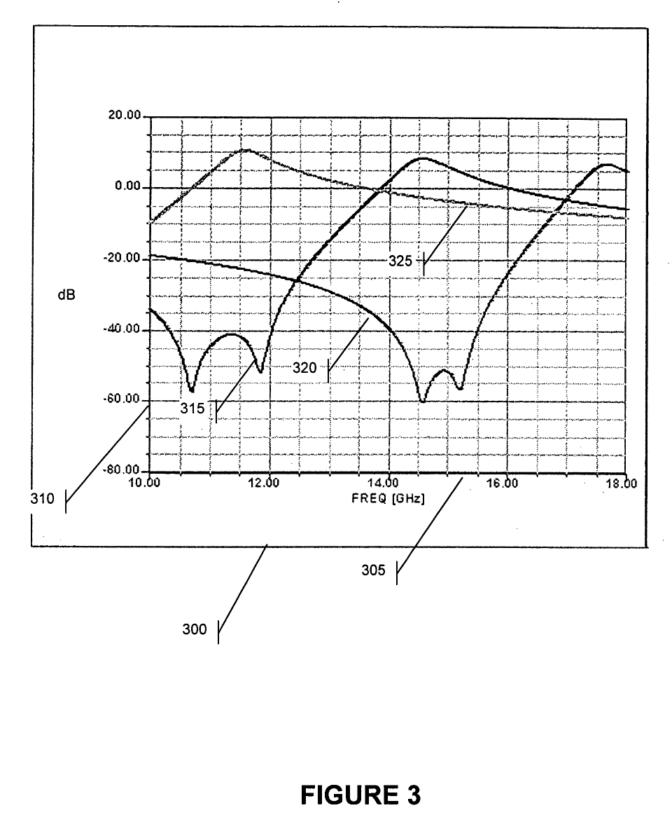

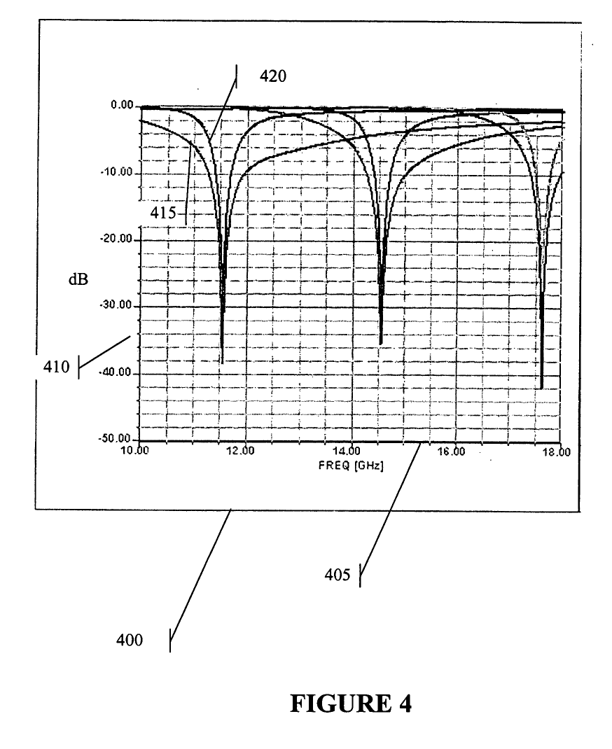

The simulated results of the circuit of FIG. 2 are shown in FIG. 3 and FIG. 4, respectively. FIG. 3 shows a graph 300 of the gain of the amplifier in dB, 310, vs. frequency 305, in GHz, at three tuning frequencies 315, 320 and 325.

The input and output return loss (match) are graphically shown in FIG. 4 at 400 as db, 410, vs. frequency 405, in GHz. A minimum useable bandwidth of 100 MHz is achieved at any tuning stage as can be seen by lines 415 and 420 of graph 400.

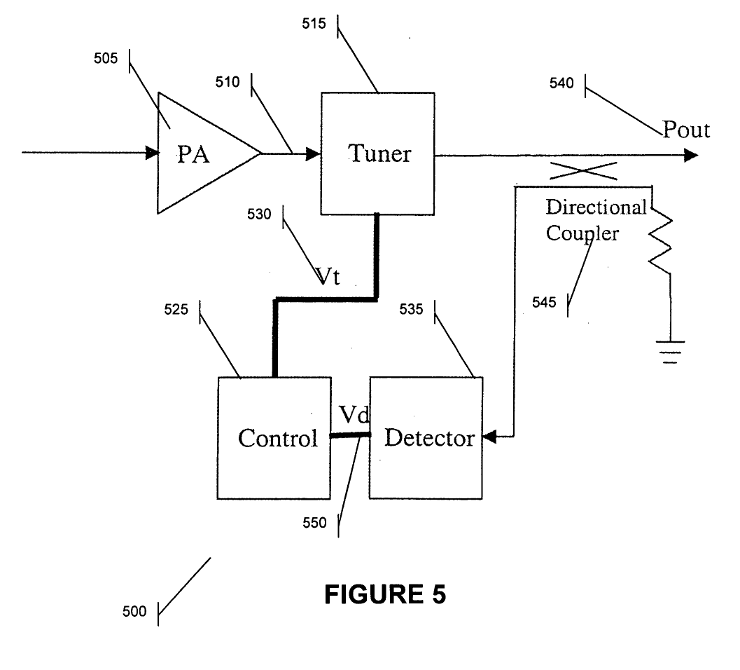

FIG. 5 at 500 depicts a second preferred embodiment of the present invention, wherein the output impedance 510 of power amplifier 505 is matched to any load impedance presented by the antenna (not shown). This is achieved by providing a feedback loop at the output 505 of the amplifier 510, and optimizing the output power. A sample of the output signal thru a directional coupler 545 will be measured by the detector 535 and converted to a DC voltage Vd 550 with level related to the RF signal power level. The Controller 525 will determine if Vd 550 is a maximum; if not, it will change the bias voltage of the varactors Vt 530 included in the matching circuit (tuner) 515. This will tune the matching circuit to provide a new output RF signal and produces a new Vd 550. This process continues until the level of Vd 550 is a maximum, which corresponds to maximum RF output signal 540. Then no further tuning is needed until there is a drift due to temperature change, for example, and the same process starts automatically until the max output power is obtained again.

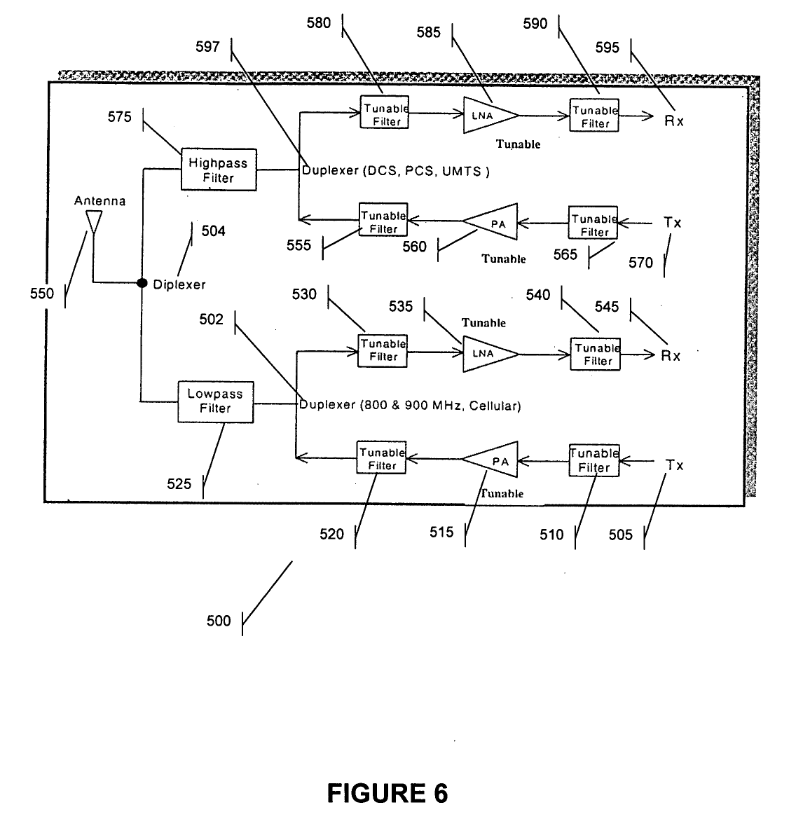

Another application is in a mobile handset as illustrated in FIG. 6. There, broadband amplifiers 515, 535, 560 and 585 using electronically tunable matching networks can be used in multi-band transceivers, as a power amplifier 515 and 560, low noise amplifier 535 and 585, or interstage amplifiers (not shown) used on both the transmit and receive side. Together with tunable filters 510, 520, 530, 540, 555, 565, 580 and 590, they can be used as part of tunable RF Front End.

Tunable filters that can be used in the present invention are described in U.S. patent application Ser. No. 09/457,943, entitled, “Electrically Tunable Filters with Dielectric Varactors” filed Dec. 9, 1999. That patent application describes a voltage tunable filter comprising an input connection point, an output connection point, and at least one circuit branch electrically coupled to the input connection point and the output connection point and including a voltage tunable dielectric varactor electrically connected to an inductor. The voltage tunable filter can be one of a low-pass, high-pass, band-pass, or band-stop filter. The varactor can include built-in DC blocking capacitors. This patent application is incorporated in by reference in its entirety and for all purposes.

Further, another voltage tunable filter is described in U.S. Pat. No. 6,525,630, entitled, “Microstrip Tunable Filters Tuned by Dielectric Varactors” issued Feb. 25, 2003. This patent, assigned to the assignee of the present invention, describes an electronic filter which includes a substrate, a ground conductor, an input, an output, a first microstrip line positioned on the substrate and electrically coupled to the input and the output, and a first tunable dielectric varactor electrically connected between the microstrip line and the ground conductor. The input preferably includes a second microstrip line positioned on the substrate and including a portion lying parallel to the first microstrip line. The output preferable includes a third microstrip line positioned on the substrate and including a portion lying parallel to the first microstrip line. The first microstrip line includes a first end and a second end, the first end being open circuited and the varactor being connected between the second end and the ground conductor. The filter further includes a bias voltage circuit including a high impedance line, a radial stub extending from the high impedance line, and a patch connected to the high impedance line for connection to a DC source. This patent application is incorporated in by reference in its entirety and for all purposes.

Referring back to FIG. 6, there is shown a multi-band radio for handset applications. It covers tri- band (DCS, PCS and UMTS) as well as, the 800 to 900 MHz cellular bands. The Diplexer will divide the signal at antenna 550 into high band, (DCS, PCS, UMTS), and low band (Cellular) using a highpass 575 and a lowpass 525 filters, respectively. Then the highband tunable duplexer 597 and low band tunable duplexer 502 and tunable interstage filters (520 and 510 for the transmit side of the low band portion; and 530 and 540 for the receive side of the low band portion; 555 and 565 for the transmit side of the high band portion; and 580 and 590 for the receive side of the high band portion) will cover the entire sub-bands, as shown. The broadband tunable LNAs 535 and 585 and PAs 515 and 560 make this configuration possible as described above.

While the present invention has been described in terms of what are at present believed to be its preferred embodiments, those skilled in the art will recognize that various modifications to the disclose embodiments can be made without departing from the scope of the invention as defined by the following claims.

What is claimed is:

1. A tunable power amplifier, comprising:
at least one input matching circuit receiving an RF signal from an RF input and creating a first output RF signal, said at least one input matching circuit including at least one voltage tunable varactor to enable center frequency tuning;
a first amplifier receiving said first output RF signal from said at least one input matching circuit and creating a second output signal, said second output signal providing input for at least one inter-stage matching circuit, said at least one inter-stage matching circuit creating a third output signal;
a second amplifier receiving said third output signal and creating a fourth output signal;
an output matching circuit receiving said fourth output signal and generating an RF output signal; and
a embedded controller associated with said input matching circuit, inter-stage matching circuit and output matching circuit, for frequency tuning control.

2. The tunable power amplifier of claim 1, further comprising at least one additional inter-stage matching circuit.

3. The tunable power amplifier of claim 1, wherein said at least one inter-stage matching circuit includes at least one tunable varactor to enable center frequency tuning.

4. The tunable power amplifier of claim 1, wherein said at least one output matching circuit includes at least one tunable varactor to enable center frequency tuning.

5. The tunable power amplifier of claim 2, wherein said at least one additional inter-stage matching circuits is one additional inter-stage matching circuit.

6. The tunable power amplifier of claim 2, wherein said at least one additional inter-stage matching circuit is two additional inter-stage matching circuits.

7. A tunable power amplifier, comprising:
a power amplifier with an input RF signal and an first output RF signal;
a tuner with at least one tunable varactor, said tuner receiving said first output signal of said power amplifier, and outputting an second RF signal;
a directional coupler for obtaining a sample of said second output RF signal and passing said sample of said second output RF signal to a detector for measuring said sample of said second output signal from said tuner; and
a controller to determine if said second output RF signal is a maximum RF signal and, if not, for adjusting a voltage applied to said at least one voltage tunable varactor in said tuner.

8. A tunable power amplifier feedback loop, comprising:
a tuner with at least one tunable varactor receiving a first output RF signal obtained from said tunable power amplifier;
a directional coupler for obtaining a sample of a second output signal output from said tuner and passing said sample of said second output RF signal to a detector for measuring said sample of said second output signal from said tuner; and
a controller to determine if said second output RF signal is a maximum RF signal and, if not, for adjusting a voltage applied to said at least one voltage tunable varactor in said tuner to modify subsequent outputs from said tuner.

9. A tunable RF front end for a mobile handset, comprising:
an antenna with a diplexer for dividing incoming and outgoing signals into high band and a low band signals;
a low pass filter receiving said low band RF signals from, and transmitting said low band RF signals to, said antenna via said diplexer;
a low band duplexer duplexing signals from a transmit side and a receive side, said transmit side comprising at least a first and second tunable filter with at least one power amplifier between said at least first and second tunable filter, said receive side comprising at least a first and second tunable filter with at least one low noise amplifier between said at least first and second tunable filter;
a high pass filter receiving said high band RF signals from and transmitting said high band RF signals to said antenna via said diplexer; and
a high band duplexer duplexing signals from a transmit side and a receive side, said transmit side comprising at least a first and second tunable filter with at least one power amplifier between said at least first and second tunable filter, said receive side comprising at least a first and second tunable filter with at least one low noise amplifier between said at least first and second tunable filter.

10. The tunable RF front end for a mobile handset of claim 9, wherein said tunable power amplifier, comprises:
at least one input matching circuit receiving an RF signal from an RF input and creating a first output RF signal, said at least one input matching circuit including at least one voltage tunable varactor to enable center frequency tuning;
a first amplifier receiving said first output RF signal from said at least one input matching circuit and creating a second output signal, said second output signal providing input for at least one inter-stage matching circuit, said at least one inter-state matching circuit creating a third output signal;
a second amplifier receiving said third output signal and creating a fourth output signal;
an output matching circuit receiving said fourth output signal and generating an RF output signal; and
an embedded controller associated with said input matching circuit, inter-state matching circuit and output matching circuit for frequency tuning control.

11. The tunable power amplifier of claim 10, further comprising at least one additional inter-stage matching circuit.

12. The tunable power amplifier of claim 10, wherein said at least one inter-statge matching circuit includes at least one tunable varactor to enable center frequency tuning.

13. The tunable power amplifier of claim 10 wherein said at least one output matching circuit includes at least one tunable varactor to enable center frequency tuning.

14. The tunable power amplifier of claim 11, wherein said at least one additional inter-stage matching circuits is one additional inter-stage matching circuit.

15. The tunable power amplifier of claim 11, wherein said at least one additional inter-stage matching circuits is two additional inter-stage matching circuits.

16. A method of tuning a power amplifier, comprising the steps of:
providing at least one input matching circuit receiving an RF signal from an RF input and creating a first output RF signal, said at least one input matching circuit including at least one voltage tunable varactor to enable center frequency tuning;
providing a first amplifier receiving said first output RF signal from said at least one input matching circuit and creating a second output signal, said second output signal providing input for at least one inter-stage matching circuit, said at least one inter-stage matching circuit creating a third output signal;
providing a second amplifier receiving said third output signal and creating a fourth output signal;
providing an output matching circuit receiving said fourth output signal and generating an RF output signal; and
adjusting the frequency tuning with an embedded controller associated with said input matching circuit, inter-stage matching circuit and output matching circuit.

17. The method claim 16, further providing at least one additional inter-stage matching circuit.

18. The method claim 16, further providing at least one inter-stage matching circuit which includes at least one tunable varactor to enable center frequency tuning.

19. The method claim 16, further providing at least one output matching circuit which includes at least one tunable varactor to enable center frequency tuning.

20. The method claim 19, wherein the step of further providing at least one additional inter-stage matching circuit is one additional inter-stage matching circuit.

21. The method claim 19, wherein the step of further providing at least one additional inter-stage matching circuit is two additional inter-stage matching circuits.

22. A method of impedance matching in a power amplifier, comprising the steps of:
providing a power amplifier with an input RF signal and a first output RF signal;
providing a tuner with at least one tunable varactor, said tuner receiving said first output signal of said power amplifier, and outputting a second RF signal;
obtaining a sample of said second output RF signal with a directional coupler and passing said sample of said second output RF signal to a detector for measuring said sample of said second output signal from said tuner; and
determining with a controller if said second output RF signal is a maximum RF signal and, if not, adjusting a voltage applied to said at least one voltage tunable varactor in said tuner.
